(19) United States
(12) Patent Application Publication
(10) Pub. No.: US 2022/0127859 A1
(43) Pub. Date: Apr. 28, 2022

(54) Remodel Nail Plate

(71) Applicant: Randall Ray Newkirk, Santa Cruz, CA (US)

(72) Inventor: Randall Ray Newkirk, Santa Cruz, CA (US)

(21) Appl. No.: 17/463,551

(22) Filed: Sep. 1, 2021

Related U.S. Application Data
(60) Provisional application No. 63/106,362, filed on Oct. 28, 2020.

(51) Int. Cl. E04F 13/074; H02G 3/30; F16B 15/00

(52) U.S. Cl. CPC E04F 13/074; F16B 15/003; H02G 3/30

(57) ABSTRACT

A remodel nail plate and installation system for a remodel nail plate adapted to protect wires, other utility support cables, and/or plumbing pipes from damage. The remodel nail plate is for insertion between a wall stud and an outer wall that is already attached to the stud, as may be the case when remodeling a home. The nail plate includes a contact edge which may be contacted with a hammer, or interstitially with an installation tool. The remodel plate is adapted to be inserted by hammering, or otherwise inserting, a plate surface between the exterior wall and the stud alongside a retrofitted cable insertion, such as a power cable.

### CROSS-REFERENCE TO RELATED APPLICATIONS

This application claims priority to U.S. Provisional Patent Application No. 63/106,362 to Newkirk, filed Oct. 28, 2020, which is hereby incorporated by reference in its entirety.

### FIELD OF THE INVENTION

The present invention is directed to a nail plate and installation system which prevents fasteners from passing through a wall and impinging upon electrical wiring and/or plumbing pipes.

### BACKGROUND

Protection plates are used during building construction to protect wires, cables, or pipes from damage later in the construction process. Wooden studs in walls may have through holes which aid in the routing of the wires, cables, or pipes. It may damage the routed cables and also cause risk to workers, electrical malfunctions, potential fire, plumbing leaks, or a combination thereof, which may lead to other damage, should there be power coursing through an impinged cable or water flowing through an impinged pipe. Building codes may require that protection plates be affixed to the interior and the exterior of a stud to protect a routed cable or pipe.

When framing a new building, there may be easy access to the areas where a protection plate is to be attached. A typical protection plate is a flat strip of metal which may have short attachment prongs that allow for the protection plate to be hammered onto the exterior surface of the stud. While these existing devices are useful, there are circumstances where they are not able to be utilized.

During the remodeling of existing structures and homes, it is not uncommon to remove the interior walls, which may be gypsum drywall. New wiring may be installed into newly drilled holes in the existing, exposed, studs. These newly routed wires may need to be protected both on the interior of the stud and on the exterior of the stud. Although the interior of the stud is exposed, and a traditional type of protective nail plate may be used, the exterior of the stud will likely already have exterior siding, or another type of exterior wall material, affixed to it. A traditional type of protective nail plate is not able to be installed in between the stud and the existing exterior wall material because the tines that attach the plate are perpendicular to the blocking plate itself and prevent the nail plate from being inserted between the stud and the wall covering.

What is called for is a protective nail plate for installation between studs and existing walls that will fixedly attach to the side of the stud. What is also called for is an installation tool and method for installing protective nail plated between studs and existing walls.

### BRIEF DESCRIPTION OF THE DRAWINGS

FIG. 1 is a top view of a remodel nail plate according to a first embodiment of the present invention.

FIG. 2 is a side view of a remodel nail plate according to a first embodiment of the present invention.

FIG. 3 is a front view of a remodel nail plate according to a first embodiment of the present invention.

FIG. 4 is a view of a stud and exterior wall with a remodel nail plate installed according to some embodiments of the present invention.

FIG. 5 is a perspective view of a prior art nail plate.

FIG. 6 is a perspective view of a remodel nail plate according to a second embodiment of the present invention.

FIG. 7 is a perspective view of a prior art nail plate.

FIG. 8 is a perspective view of a remodel nail plate according to a third embodiment of the present invention.

FIG. 9 is a perspective view of a remodel nail plate according to a second embodiment of the present invention.

FIG. 10 is a rear view of remodel nail plate according to a second embodiment of the present invention.

FIG. 11 is a front view of a remodel nail plate according to a second embodiment of the present invention.

FIG. 12 is a view of a remodel nail plate partially installed according to some embodiments of the present invention.

FIG. 13 is a perspective view of a remodel nail plate according to a third embodiment of the present invention.

FIG. 14 is a rear view of remodel nail plate according to a third embodiment of the present invention.

FIG. 15 is a front view of a remodel nail plate according to a third embodiment of the present invention.

FIG. 16 is an illustration of the installation of a remodel nail plate according to some embodiments of the present invention.

FIG. 17 is a sketch of an installation tool for a remodel nail plate according to some embodiments of the present invention.

### SUMMARY OF THE INVENTION

A remodel nail plate and installation system for a remodel nail plate adapted to protect wires, other utility support cables, and/or plumbing pipes from damage. The remodel nail plate is for insertion between a wall stud and an outer wall that is already attached to the stud, as may be the case when remodeling a home. The nail plate includes a contact edge which may be contacted with a hammer, or interstitially with an installation tool. The remodel plate is adapted to be inserted by hammering, or otherwise inserting, a plate surface between the exterior wall and the stud alongside a retrofitted cable insertion, such as a power cable.

### DETAILED DESCRIPTION

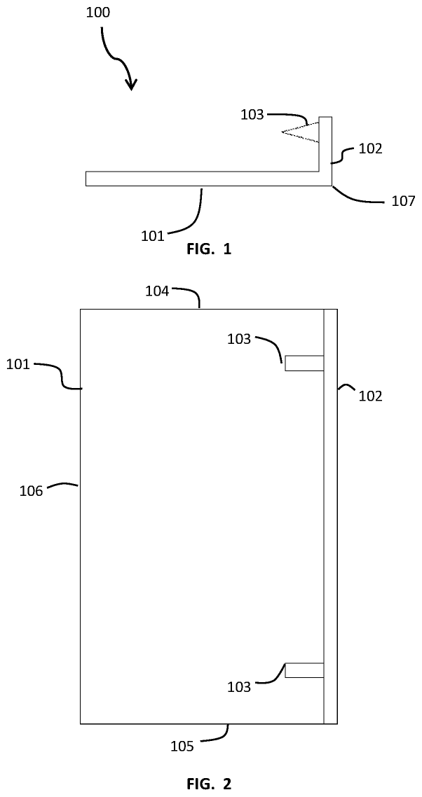

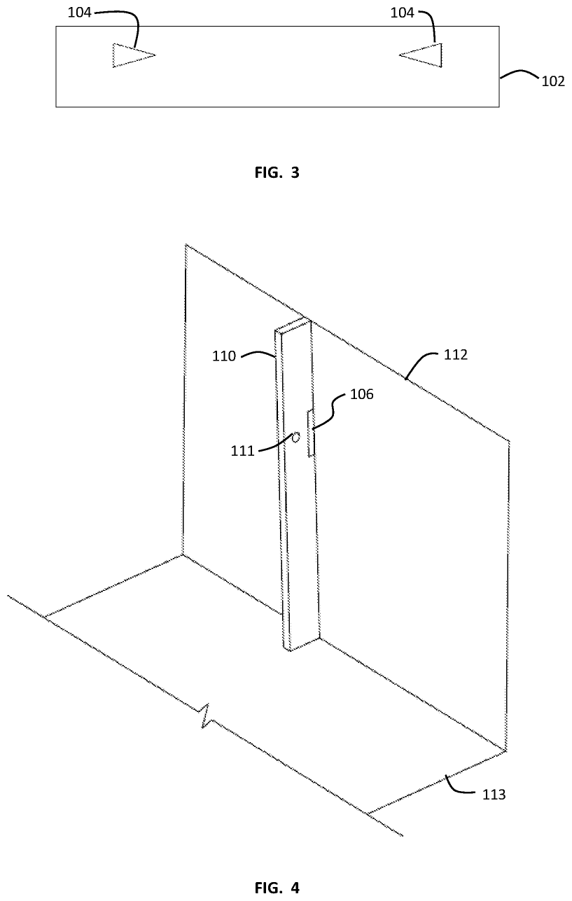

In a first embodiment of the present invention, as seen in FIGS. 1-3, a remodel nail plate 100 is adapted for insertion between a wall stud and an outer wall that is already attached to the stud in order to protect wires routing through a hole in the stud. In many circumstances, new wiring, or plumbing, or a combination or both, may be installed in walls during a remodel. The new wiring may traverse through studs via holes drilled in the stud. The interior walls of the structure, such as sheetrock walls, may be removed during the remodel while the exterior wall remains in place. Building codes may require both sides of a stud in the area of the hole be protected with a metal plate in order to provide protection.

The remodel nail plate 100 may have a blocking plate 101 which is of sufficient thickness and hardness to provide protection against driven nails and other types of intrusions. The blocking plate 101 may be substantially rectangular and have two longer edges 106, 107 and two shorter edges 104, 105. A leading edge 106 is the edge which will be inserted between the stud and the exterior wall. A capture plate 102 is substantially rectangular and is coupled to the blocking plate 101 along a long edge. In some aspects, the remodel nail plate is formed from a single piece of metal and is formed to provide the right angle bend between the blocking plate and the capture plate.

One or more attachment tines 103 protrude from the capture plate in a direction approximately parallel to the plane of the blocking plate 101. In some aspects, the attachment tines 103 are punched out of the blocking plate 101 and there remain tine voids 104 in the capture plate. In some aspects, the attachment tines are located along the edge of the capture plate in order to facilitate the punching out process. Although illustrated with the attachment tines perpendicular to the blocking plate, in some aspects the attachment tines may be parallel to the blocking plate, which may facilitate installation of the tines along the grain of the wood.

FIG. 4 illustrates an installed remodel nail plate 100. The remodel nail plate has had its leading edge 106 inserted between a stud 110 and an exterior wall 112 at a vertical station along a wiring hole 111. The stud 110 may reside on a floor 113 or on other framing members. The remodel nail plate may be struck with an insertion aid, such as a hammer, on the capture plate until the attachment tangs contact the side of the stud, and then further struck until the tangs insert into the wood and the capture plate resides against the stud. With the attachment tangs affixed into the stud, and the capture plate then also against the stud, the remodel nail plate will remain firmly and fixedly attached to the stud.

In some aspects, the capture plate 102 may include an interface for an installation tool. In some aspects, the capture plate 102 may be indented features, such as dimples in the plate, adapted to mate with matching protrusions on an interface end of the installation tools. The installation tool may have a pounding interface on a first end, and a broader plate with protrusions on a second end. In some aspects, the installation tool may have one or more magnets on the interface end, and the remodel nail plate will magnetically couple to the installation tool such that the tool may be used to guide the remodel nail plate to the appropriate location to begin its insertion and installation. In an exemplary embodiment, the remodel nail plate is 3 inches by 1.5 inches by 0.5 inches. In some aspects, the tines may be pointed to allow for easier penetration into the stud.

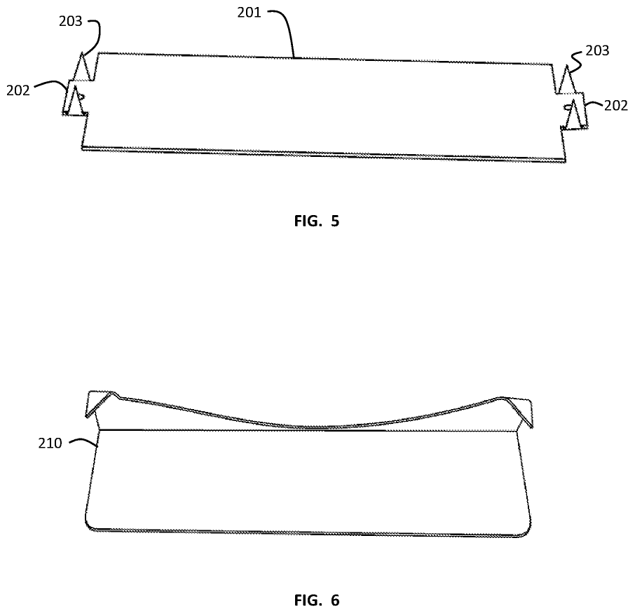

FIG. 5 illustrates a prior art nail plate 201 which is typically used in new construction. In this example, which may be used to block the side of a 2 inch by 4 inch stud, is pounded into the stud and affixed by the tines 203 which are coupled to the end protrusions 202. In this type of installation, the direction of the pounding is perpendicular to the edge of the stud which is being covered with the nail plate.

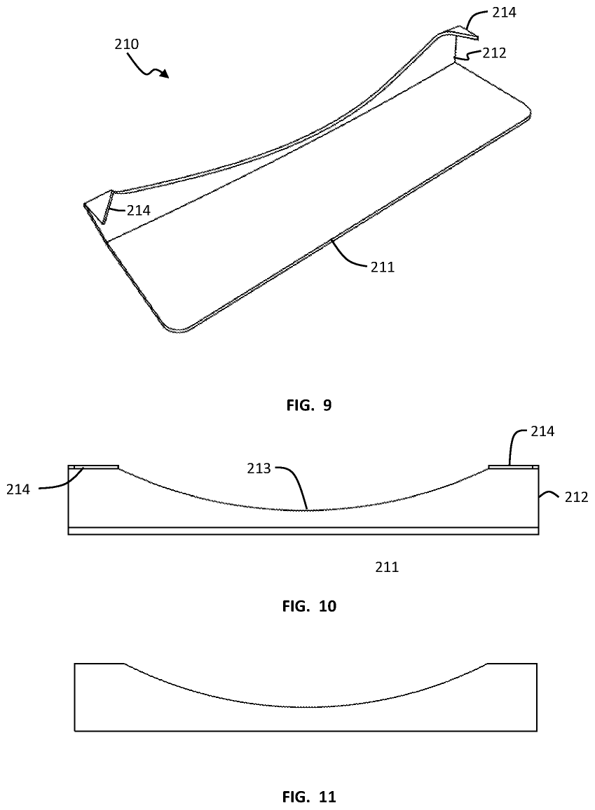

FIGS. 6 and 9-11 illustrate a remodel nail plate 210 according to a second embodiment of the present invention. The remodel nail plate 210 may be used along the narrow side of a 2×4 stud, and is adapted to be inserted along short edge of the 2×4 with the pounding/installation direction parallel to the blocking plate 211. The remodel nail plate 210 may be affixed by providing force behind the capture plate 212 until the tines 214 pierce the stud, until the capture plate is flush with the side of the stud. In some aspects, a recess 213 on the capture plate 212 provides clearance for the hole in the stud and the utilities 114 which may be routed through the hole 111. Although the remodel nail plate 210 is also adapted to be installed inside the exterior wall 112, outside of the stud 110, it is also able to be installed on an interior bare portion of the stud. In some aspects, the remodel nail plate is long enough to block a single utility, such as a single hole routing a wire, and may be three inches long, for example. In some aspects, the remodel nail plate is longer and is adapted to block a plurality of holes which may be spaced vertically along the stud, and may be six inches long, for example.

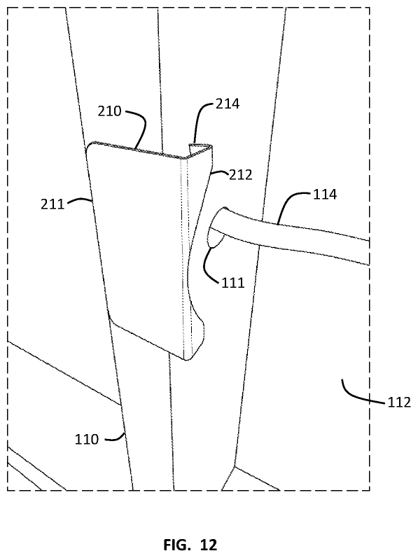

FIG. 12 illustrates a remodel nail plate 210 in a partially installed position on a stud 110. The blocking plate 211 is flush against the stud, and the tines 214 have begun to piece the stud.

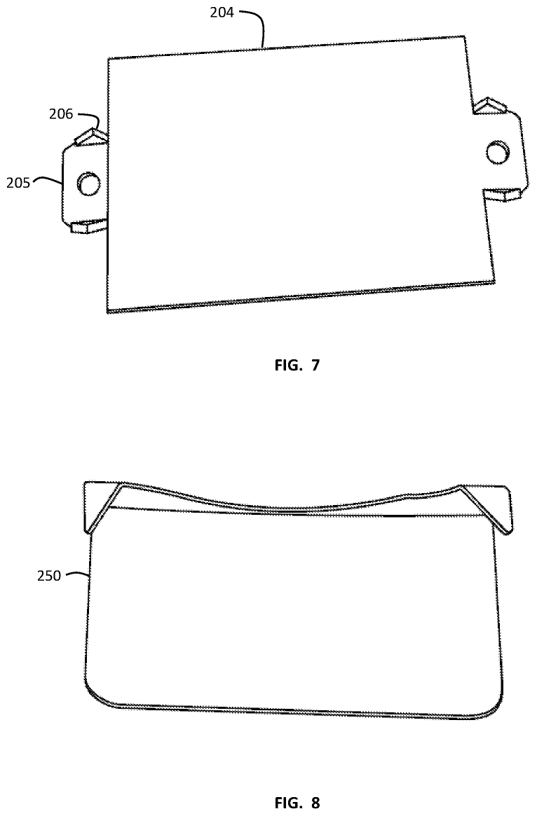

FIG. 7 illustrates a prior art nail plate 204 which is typically used in new construction. In this example, which may be used to block the wider side of a stud, or, for example, if two studs are in place next to each other, or a wider stud is used, is pounded into the stud and affixed by the tines 206 which are coupled to the end protrusions 205. In this type of installation, the direction of the pounding is perpendicular to the edge of the stud which is being covered with the nail plate.

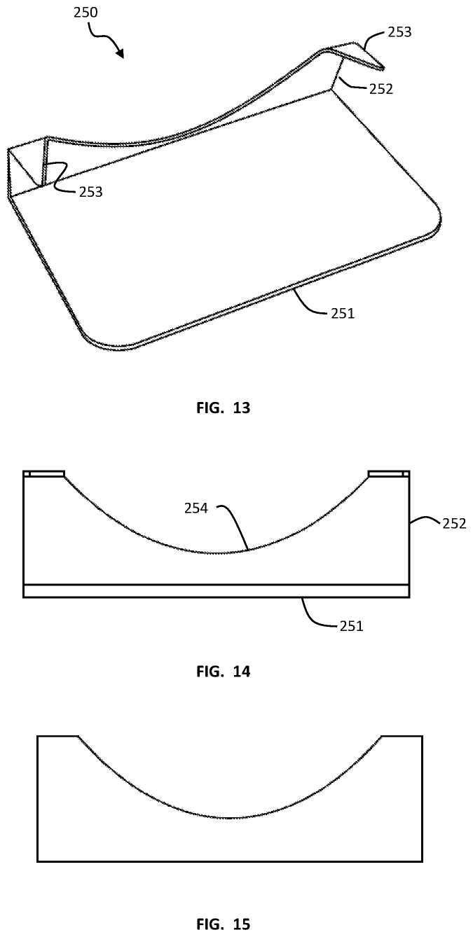

FIGS. 8 and 13-15 illustrate a remodel nail plate 250 according to a second embodiment of the present invention. The remodel nail plate 250 may be used along the wide side of a 2×4 stud, or if two studs are in place next to each other, and is adapted to be inserted with the pounding/installation direction parallel to the blocking plate 251. The remodel nail plate 250 may be affixed by providing force behind the capture plate 252 until the tines 253 pierce the stud, until the capture plate is flush with the side of the stud. In some aspects, a recess 254 on the capture plate 252 provides clearance for the hole in the stud and the utilities 114 which may be routed through the hole 111. Although the remodel nail plate 250 is also adapted to be installed inside the exterior wall 112, outside of the stud 110, it is also able to be installed on an interior bare portion of the stud.

In some embodiments of the present invention, a method of blocking a stud to protect utilities comprises the steps of removing the inner wall covering of a wall; placing a remodel nail plate along the interior of an exterior wall where said exterior wall meets a stud; inserting said remodel plate between said stud and said interior of an exterior wall; and affixing said remodel nail plate to said stud by penetrating said stud with attachment tines on the nail plate. In some aspects, the nail plate may be magnetically coupled to an installation tool which includes an interface end and an installation end. The installation end may be adapted to be pounded by a hammer, with the installation tool then driving the remodel nail plate against its capture plate. The installation is complete when the tines have penetrated the stud to the point where the capture plate is flush against the stud.

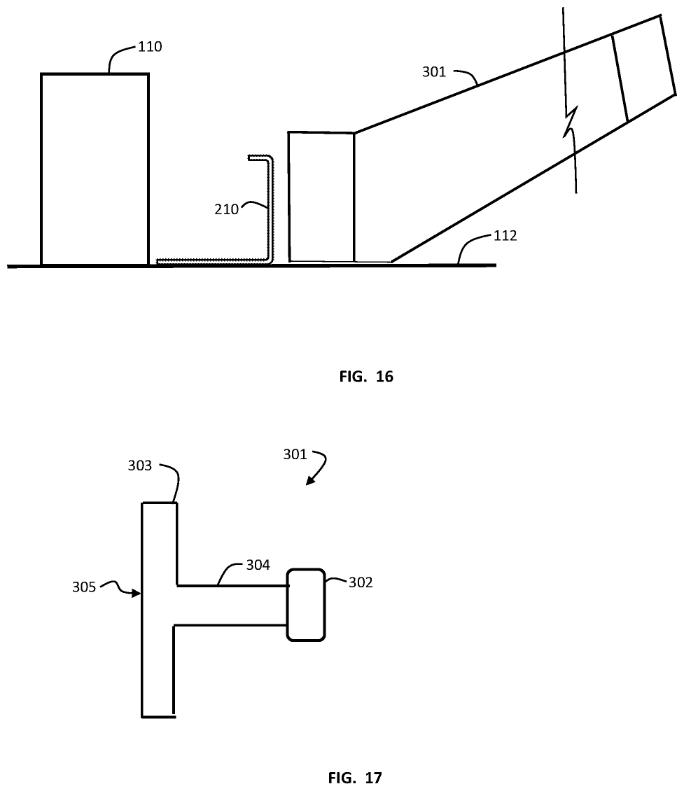

FIG. 16 illustrates an installation tool 301 which may be used to install a remodel nail plate 210 between a wall 112 and a stud 110 according to some embodiments of the present invention. The remodel nail plate 210 is adapted to have its blocking plate inserted between the wall and the stud. The installation tool may be hit with a hammer or other suitable implement to drive the remodel nail plate into its installed position where the remodel nail plate is affixed to the stud with the tines on the capture plate. In some aspects, the installation tool 301 may be aligned so that the middle section 304 is not perpendicular to the mating surface 305 on the plate interface 303 of the second end, but is angled so that the hammer striking the impact end 302 may have clearance from the next interior stud. In some aspects, the installation tool is planar and has its central section in line with the first end and the second end.

FIG. 17 illustrates an installation tool 301 according to some embodiments of the present invention. The tool may have a first end 302 adapted to be hit with a hammer or other device, and may have a broader plate 303 on a second end. In some aspects, the installation tool may have a magnet or magnetic portion on the mating surface 305 which is used to provide force against the nail plate during installation, and is adapted to hold the remodel nail plate to the installation tool to assist in installing the remodel plate. A central section 304 between the first end 302 and the second end 303 may be held by the user during use. In some aspects, the mating surface 305 may have raised sections or recesses adapted to mate with a mating feature on the nail plate.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A remodel nail plate for providing protection for a utility line within a wall stud, said remodel nail plate comprising:
a substantially flat planar blocking member, said blocking member having a substantially rectangular shape with a first and second long edge; and
a substantially flat planar capture plate, said capture plate having a first edge and second edge, said first edge of said capture plate coupled to said first edge of said blocking member, said second edge opposite of said first edge, said capture plate comprising one or more attachment tines protruding from said capture plate in a direction parallel to the plane of said blocking member.

2. The remodel nail plate of claim 1 wherein said capture plate comprises a recess along a middle section of said section edge.

3. The remodel nail plate of claim 1 wherein said capture plate further comprises indentations adapted to receive an insertion tool.

4. The remodel nail plate of claim 2 wherein said capture plate further comprises indentations adapted to receive an insertion tool.

5. A remodel nail plate kit, said remodel nail plate kit comprising:
a remodel nail plate, wherein said remodel nail plate comprises:
a substantially flat planar blocking member, said blocking member having a substantially rectangular shape with a first and second long edge; and
a substantially flat planar capture plate, said capture plate having a first edge and second edge, said first edge of said capture plate coupled to said first edge of said blocking member, said second edge opposite of said first edge, said capture plate comprising one or more attachment tines protruding from said capture plate in a direction parallel to the plane of said blocking member; and
an installation tool; wherein said installation tool comprises:
an impact end; and
a plate interface end.

6. The remodel nail plate kit of claim 2 wherein said remodel nail plate further comprises an indented interface on said capture plate, and wherein said plate interface end of said installation tool comprises protrusions adapted to fit into said indented interface of said capture plate.

7. The remodel nail plate kit of claim 1 wherein said plate interface end of said installation tool comprises a magnet.

8. The remodel nail plate kit of claim 2 wherein said plate interface end of said installation tool comprises a magnet.

9. A method of blocking a stud during remodeling to protect new utilities, said method comprising the steps of:
removing the inner wall covering of a wall;
placing a remodel nail plate along the interior of an exterior wall where said exterior wall meets a stud;
inserting said remodel plate between said stud and said interior of an exterior wall; and
affixing said remodel nail plate to said stud by penetrating said stud with attachment tines on the nail plate.

10. The method of claim 9 further comprising the step of drilling a hole in said stud.

11. The method of claim 9 wherein said remodel nail plate comprises:
a substantially flat planar blocking member, said blocking member having a substantially rectangular shape with a first and second long edge; and
a substantially flat planar capture plate, said capture plate having a first edge and second edge, said first edge of said capture plate coupled to said first edge of said blocking member, said second edge opposite of said first edge, said capture plate comprising one or more attachment tines protruding from said capture plate in a direction parallel to the plane of said blocking member.

12. The method of claim 10 wherein said remodel nail plate comprises:
a substantially flat planar blocking member, said blocking member having a substantially rectangular shape with a first and second long edge; and
a substantially flat planar capture plate, said capture plate having a first edge and second edge, said first edge of said capture plate coupled to said first edge of said blocking member, said second edge opposite of said first edge, said capture plate comprising one or more attachment tines protruding from said capture plate in a direction parallel to the plane of said blocking member.

13. The method of claim 12 wherein said capture plate comprises a recess along a middle section of said section edge, and wherein said hole aligns with said recess.

14. The method of claim 9 wherein the step of placing a remodel nail plate along the interior of an exterior wall where said exterior wall meets a stud comprises the steps of:
placing a remodel nail plate onto the plate interface end of an installation tool; and
placing the remodel nail plate along the interior of an exterior wall.

15. The method of claim 9 wherein said plate interface end of the installation tool comprises a magnet, and wherein the step of placing a remodel nail plate onto the plate interface end of an installation tool comprises magnetically coupling the remodel nail plate to the plate interface end of the installation tool.
